(19) United States
(12) Patent Application Publication
(10) Pub. No.: US 2005/0110729 A1
(43) Pub. Date: May 26, 2005

(54) Display system

(76) Inventors: Ronald S. Cok, Rochester, NY (US); Bernard Masson, Rochester, NY (US)

Correspondence Address: Milton S. Sales;Patent Legal Staff, Eastman Kodak Company, 343 State Street, Rochester, NY, 14650-2201, US

(21) Appl. No.: 10/723,106

(22) Filed: Nov. 26, 2003

(51) Int. Cl. G09G 3/32

(52) U.S. Cl. 345/82

(57) ABSTRACT

A display system, method for assembling a display system, and method for vending a display system are provided. The display system has a display, a write-once solid-state memory with image content stored in the write-once memory, and a display controller adapted to read the write-once memory and to cause the display to present the image content.

### FIELD OF THE INVENTION

This invention relates generally to a display system and, more particularly, to sharable display device with customizable image storage.

### BACKGROUND OF THE INVENTION

Flat-panel display devices are becoming increasing prevalent and cost-effective for a wide variety of applications. One popular use of such display devices is the presentation of image content such as video image sequences. Display devices of this type typically include components such as display controllers, interactive user interface devices, and computers. Such general-purpose computers, displays, and interfaces are relatively costly.

Video image sequences are used for a variety of purposes, including entertainment. For example, video playback from videotapes or Digital Versatile Disks (DVDs) is well known and a variety of portable devices for presenting video image sequences are available on the market today. Video image sequences can be personalized and shared with others in order to communicate from one specific individual to another. Such video greetings are well-known and typically take the form of digital data files sent by email and played back on a computer. Alternatively, such video greetings are stored on a DVD and physically sent to a desired recipient. Video greeting cards are also known.

U.S. Pat. Pub. No. 2003/0086684 A1 entitled “Video Greeting Apparatus” filed Oct. 16, 2002, describes an apparatus and method for producing a video message, particularly a greeting or post card, comprising a camera for viewing a user, video recording means for recording a message on a video recording medium, such as a CD or DVD, and means for vending the recording in or with an envelope or the like. This requires that the recipient have available a computer or other means to play back a recording.

A more general customized method for sharing a video sequence is described in U.S. Pat. Pub. No. 2002/0138843 A1 entitled “Video Distribution Method and System” filed May 18, 2001. In this method at least one video clip is received from each of a plurality of user parties over a computer network and the received video clips are stored at a central location in groups defined by the user parties. Requests are received from a plurality of recipient parties over the computer network each identifying a respective one of the user parties and also identifying a video clip that has been uploaded by the identified user party for storage at the central location. At least one video clip identified in the respective request from that recipient party is transmitted to the recipient party. The video distribution system contemplates a filtering process whereby the recipient parties are permitted only selective access to the entire video collection of any particular user. The video distribution system also provides a procedure for providing video clips to the recipient parties as components of a combined graphics and video transmission. A user party selects a graphic illustration and a video clip for co-transmission as a video greeting card. In response to a request from a given recipient party, the graphic illustration and the video clip are transmitted over the computer network to that given recipient party so that the selected graphic illustration and the selected video clip appear on the monitor of the recipient in temporal and spatial juxtaposition. Such a system also requires an expensive playback system and a complex communication system.

Thus, there remains a need for an apparatus and method for sharing personalized video sequences. One concept for meeting this need has been described for example, in a research disclosure entitled “video postcard” that was described in a book entitled “Vision of the Future” published in 1996 by Philips Corporate Design, Eindhoven, The Netherlands. This publication describes the advantages of a flat, postcard size piece of film in which a chip is embedded. The chip can store a short clip (5-10 seconds) of sound and moving images. The film can be treated as a post card and sent via conventional post or it can be used to store short messages for friends or relatives.

However, the commercial viability of such a system depends upon the ability to provide such a system in a way that has a relatively low cost. Indeed many conventional display types and systems can be used to perform such a function where the cost of the post card is not a limiting factor. What is needed therefore is a low cost apparatus for sharing video sequences and cost efficient methods that enable the distribution, vending, and sharing of the same.

### SUMMARY OF THE INVENTION

In one aspect of the invention, a display system is provided. The display system has a display, a write-once solid-state memory with image content stored in the write-once memory, and a display controller adapted to read the write-once memory and to cause the display to present the image content.

In another aspect of the invention, a display system is provided. The display system comprises a display, a write-once memory with image content stored in the write-once solid-state memory, a display controller adapted to read the write-once solid-state memory and to cause the display to present the image content and a folded surface on which any of the display, the write-once solid-state memory and display controller are mounted.

In yet another aspect of the invention, a display system is provided comprising a display, a memory interface adapted to receive more than one type of write-once solid-state memory with each type of write-once solid-state memory having a different capacity for receiving image content. A display controller is adapted to read image content stored in a write-once solid-state memory received by the memory interface and to cause the image content to be presented by the display.

In another aspect of the invention, a method of assembling a display system is provided. In accordance with the method, a display is provided, a write-once solid-state memory is provided and a display controller is provided with display controller, write-once solid-state memory and display being functionally associated so that the display controller can read the write-once memory and can cause the display to present image content stored in the write-once memory.

In a further aspect of the invention, a method of vending a display system having a display, a write-once solid-state memory and a display controller for reading the write-once memory and displaying the image content on the display is provided. In accordance with the method comprising image content is obtained. The image content is stored in the write-once solid-state memory, the display system is sold and the display system delivered.

### ADVANTAGES

The video greeting card according to the present invention is advantageous in that it provides a low-cost, simple video greeting card system for customized image sequences that do not require additional playback equipment.

### BRIEF DESCRIPTION OF THE DRAWINGS

FIG. 1 is a schematic diagram of a video greeting card according to an embodiment of the present invention;

FIG. 2 is a schematic diagram of a video greeting card integrated into a card according to another embodiment of the present invention;

FIG. 3 is a schematic diagram showing the integration of components within a video greeting card according to an embodiment of the present invention; and

FIG. 4 is a schematic diagram of a kiosk for creating and vending video greeting cards according to the present invention.

### DETAILED DESCRIPTION OF THE INVENTION

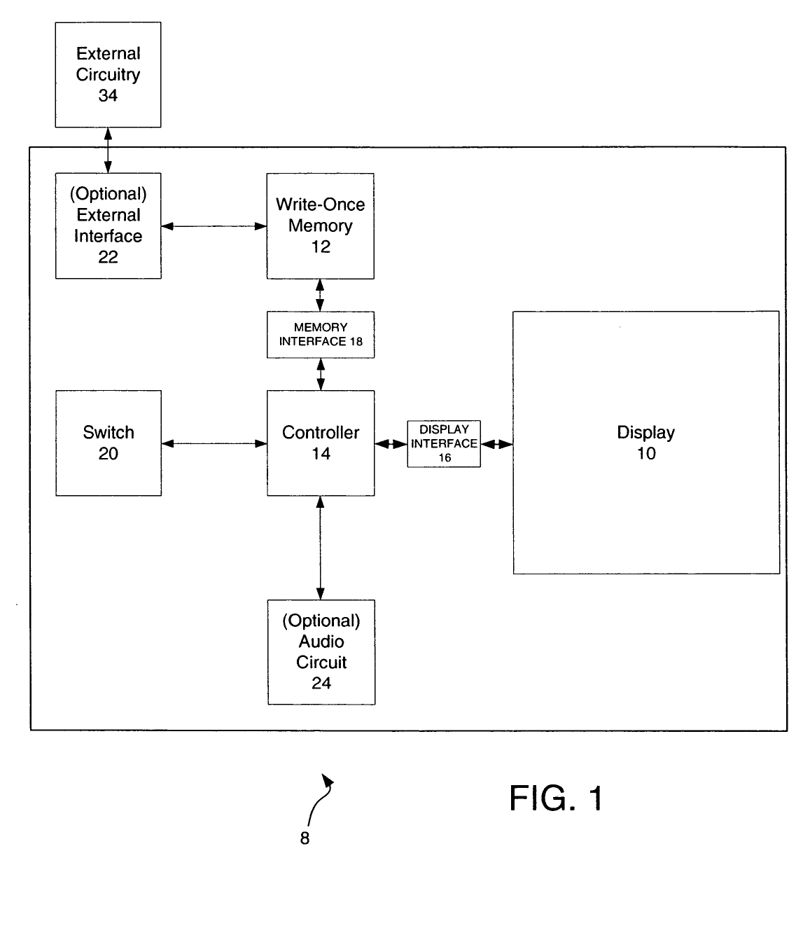

Referring to FIG. 1, one embodiment of a display system 8 according to the invention is shown. In this embodiment, display system 8 has a display 10, a write-once solid-state memory 12, for example, a Read Only Memory (ROM) manufactured as an integrated circuit having image content such as one or more images, an image sequence, or a stream of image information or any other form of video or graphic content stored therein, a switch 20, and a display controller 14 responsive to the switch 22 for reading the write-once memory 12 and displaying the image content on display 10. The display controller 14 includes a display interface 16 to display 10 and a memory interface 18 to write-once memory 12.

Display controller 14 can be a programmable display controller such as a microprocessor, microcontroller or programmable analog device. Alternatively display controller 14 can be of a type that is not programmable and in this alternative can include a memory interface and display driver. Such a non-programmable embodiment of display controller 14 can be implemented for example with a state machine or hard-wired logic circuit. Such an alternative construction provides a low cost and low power display controller 14 that can perform the functions described herein.

An external interface 22 is optionally provided. In the embodiment shown, external interface 22 is accessible to external circuitry 34. When interface 22 is connected to external circuitry 34, for example, by way of a Universal Serial Bus connector, external interface 22 receives image content from external circuitry 34 and stores this image content in the write-once solid-state memory 12. In another alternative, external interface 22 can receive image content that is transmitted wirelessly, for example, by way of radio frequency, optical or other known wireless transmission techniques. A power cell (not shown), for example a battery, provides power to display 10, memory 12, display controller 14, display interface 16, memory interface 18, switch 20 and/or external interface 22.

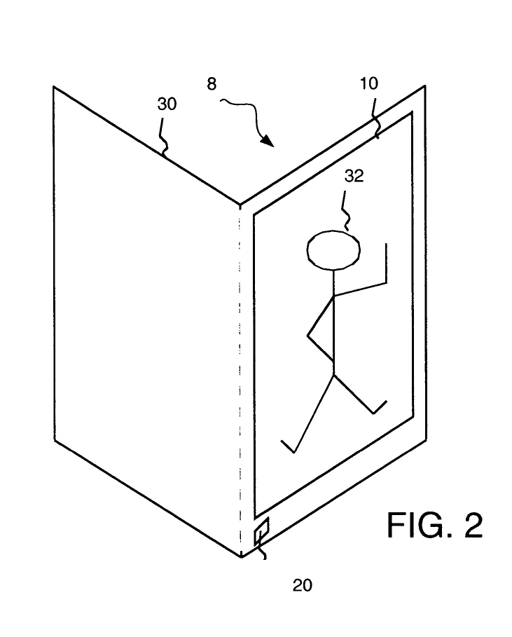

Referring to FIG. 2, one embodiment of display system 8 is shown wherein display system 8 is mounted on a surface 30 made of, for example, light-weight cardboard and with additional text or graphics imprinted thereon. In the embodiment shown, surface 30 is a folded like a greeting card, and switch 20 is mounted on one face of surface 30 so that as the surface 30 is unfolded, switch 20 closes an electrical circuit. The closed circuit is detected by the display controller 14, which proceeds to read the image content stored in the write-once solid-state memory 12 and causes the image content that is read, for example image 32, to be presented on display 10. An audio signal may also be associated with image content that is stored in write-once solid-state memory 12 to enhance the user experience.

Accordingly, in the embodiment shown in FIGS. 1 and 2, an optional audio output system 24 can be incorporated into display system 8 to convert such an audio signal into an audible form. Audio playback methods are well-known and enabling devices are commercially available.

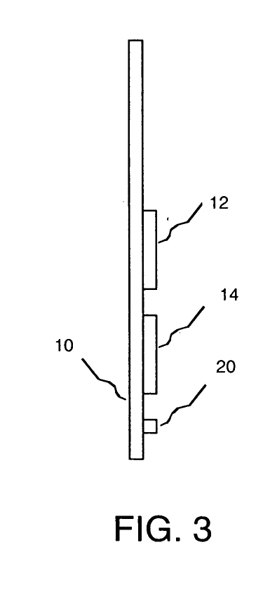

It is useful to minimize the thickness of display system 8 to mimic, as closely as possible, conventional printed communications for example, cards, photographic prints, paper media and the like. To this end, the components such as display 10, write-once solid-state memory 12, display controller 14, and switch 20 making up display system 8 can be assembled on the back or face of display 10 as shown in the embodiment shown in FIG. 3. In particular, it may be useful to have display controller 14 and write-once memory 12 affixed to the back of the display 10 and switch 20 to be affixed to a face of the display 10 or otherwise positioned so that it can be conveniently actuated by a recipient of display system 8. Various means for actuating a switch upon the opening of a card are known in the art, for example with audio greeting cards available today. Alternatively, display controller 14 can have a timer (not shown) for causing the image content to be presented on display 10 at selected times. Other convenient ways for activating display controller 14 to cause image content stored in write-once solid-state memory 12 can be used.

Display system 8 can take other forms. For example, display system 8 can take the form that is consistent with the form of a conventional collectable/trading card such as a baseball card, a football card, or the like, a collectable/trading card of the type that currently carries images of fanciful characters thereon, and/or other forms of collectable memorabilia. Display system 8 can also be incorporated onto flexible and/or foldable embodiments of surface 30 to provide a wide variety of items.

Display controller 14 and write-once solid-state memory 12 can be combined into a single integrated circuit and/or potted together, for example, using a protective resin to provide a small, low-cost circuit and can include an interface (not shown) to engage display 10. Any protective material applied to the circuitry may be applied after the image content is written to the write-once solid-state memory 12.

In operation, a mass-produced image sequence can be written into the write-once solid-state memory 12 using external circuitry 34. Alternatively, a purchaser of display system 8 can first create image content, for example using a digital video camera and then write the image content into the write-once solid-state memory 12 using the external circuitry 34. The external circuitry 34 can also provide additional power to display system 8 during writing and may also charge the power cell. When display system 8 is subsequently activated, the image content is played back.

Write-once solid-state memory 12 may be composed of a variety of integrated circuits, for example read-only memory integrated circuits. Suitable read-only memory is available today at a high density and is lower in cost or size than equivalent read/write memory or rotating storage medium.

It will be appreciated that a manufacturer, supplier, wholesaler or retailer of display system 8 may wish to incorporate image content in display system 8. Alternatively customers may wish to provide customized image content. Since it is likely that the means for writing customized content into the write-once solid-state memory will not be available to all customers, it is useful to provide the capability in a publicly accessible kiosk, a retail facility, a mail order provider or an internet merchant.

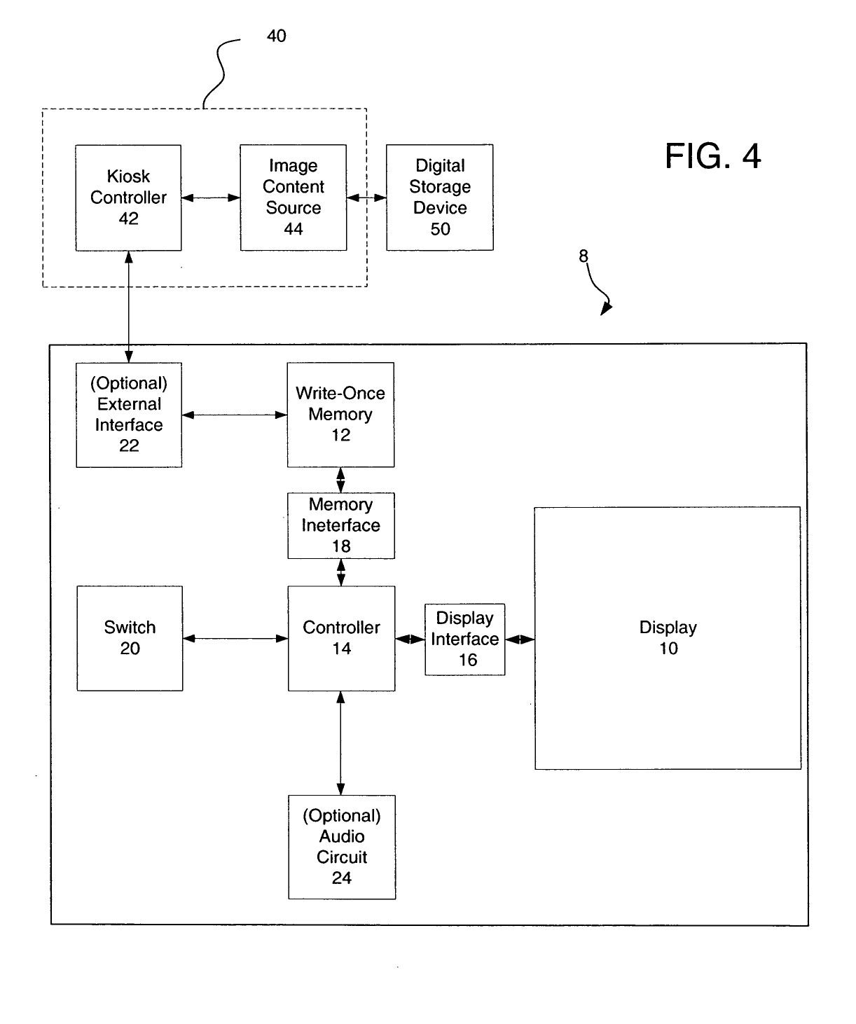

In one embodiment, shown in FIG. 4, memory interface 18 is provided in a manner that is adapted to receive more than one type of write-once solid-state memory 12. In this embodiment, display device 8 is provided in a form that is adapted to receive a write-once solid-state memory 12 as described above, but that does not have one installed until the time that the display device is sold at retail. This permits a vendor or manufacturer with the flexibility to install different types of write-once solid-state memories 12 into display device 8 so that, for example, less expensive memories can be used where the display system is to present image content such as a set of individual still images that does not occupy a significant amount of memory capacity, and, conversely, to install more expensive memories where for example display system 8 is to present image content that occupies a significant amount of memory capacity such as streams of video content and associated audio content. In this way, the costs of the overall display system can be controlled based upon the type and amount of content that is to be stored on display device 8.

This embodiment also enables a retail vendor, customer or other person to program image and/or audio content into the write once solid-state memory 12 while the write-once solid-state memory 12 is separate from the display device. This may be useful where it is desired to program multiple write-once solid-state memories 12 at the same time using equipment that specializes in such actions.

Further, the separability of the write-once solid-state memory 12 from the display device 8 can make it possible to use the same display device 8 to present more than one set of image content. For example, it will be appreciated that it maybe desired for display system 8 to be located in a favorable location and for the user of display system 8 to obtain preferred image content in the form multiple write-once solid-state memories each having one set of image content and to select one of the write-once solid-state memories for insertion into memory interface 18 of display device 8. In this way display device 8 can be used to present more than one set of image content.

Referring to FIG. 4, a kiosk embodiment 40 of external circuitry 34 is shown. As shown in FIG. 4, in this embodiment kiosk 40 includes a kiosk display controller 42 including one or more content source interfaces 44 to one or more digital storage device 50. Digital storage device 50 can comprise, for example, a digital device such as a Personal Digital Assistant (PDA), a digital still camera, a digital video camera, a digital communication network such as the Internet or a digital telephone network or any other digital device that can communicate with image content source interface 44 and provide image content to kiosk 40. Image content source 44 can communicate with digital storage device 50 using wired means for example to communicate with the well known memories such as SD cards, PCMCIA cards, floppy disks, CDs, and CompactFlash cards. Image content source 44 can also communicate with digital storage device 50 using wireless means such as radio frequency communications, optical communications and telecommunications systems. Kiosk display controller 42 can read image content from the customer digital storage device 50 and write the image content into write-once solid-state memory 14 using external interface 22. Techniques for managing user interfaces for the transfer and writing of images are well known in the art and are commercially seen, for example, in the Kodak Picture Maker kiosks sold by Eastman Kodak Company, Rochester, N.Y., USA.

In one embodiment, kiosk 40 can vend a display system 8 by first obtaining image content, for example, by capturing a digital image, or accepting image content from a digital medium or from an electronic signal bearing image content transmitted by a remote device. Kiosk display controller 42 then processes the received image content as necessary and stores the received and optionally processed image content in the write-once solid-state memory 12 of display system 8. Kiosk sells display system 8, for example, by requiring a purchaser to provide some form of payment and by executing a payment transaction using payment transaction systems that are well known in the art and provides display system 8 to a customer. Alternatively, kiosk 40 can send the display system 8 to the customer or to some other person designated by the customer by way of conventional package transport.

Display 10 of the present invention can be implemented with a variety of flat-panel display technologies, including organic light emitting diode (OLED) displays or liquid crystal displays (LCDs). In particular, since low-cost and low-power display devices are useful in the present invention, reflective passive-matrix displays may be employed because they do not require energy for light emission and are well-suited to low-cost control and manufacturing methods. One such display using bi-stable cholesteric materials is described in U.S. Pat. No. 5,437,811 entitled Liquid Crystalline Light Modulating Device filed by Doane et al. on Oct. 30, 1992. Such displays can be made on flexible substrates and with low-cost roll-to-roll or continuous manufacturing methods thereby reducing cost and providing useful attributes in a greeting card application.

The invention has been described in detail with particular reference to certain preferred embodiments thereof, but it will be understood that variations and modifications can be effected within the spirit and scope of the invention.

### Parts List

8 display system
10 display
12 write-once solid-state memory
14 display controller
16 display interface
18 memory interface
20 switch
22 external interface
24 audio circuit
30 surface
32 image
34 external circuitry
40 kiosk
42 kiosk display controller
44 image content source
50 digital storage device

1. A display system comprising:
a display;
a write-once solid-state memory with image content stored in the write-once memory; and
a display controller adapted to read the write-once memory and to cause the display to present the image content.

2. The display system of claim 1 wherein the display is a flexible display.

3. The display system of claim 1 wherein the display is a flat panel display.

4. The display system of claim 1 further comprising an interface to the write-once solid-state memory for writing the image content to the memory.

5. The display system of claim 1 wherein any of the write-once memory, and the display controller are mounted on the back of the display.

6. The display system of claim 1 wherein the display controller further comprises a timer causing the display controller to display the image content at a predetermined time.

7. The display system of claim 1 wherein the display is an OLED display.

8. The display system of claim 1 wherein the image content is at least one of a motion image sequence, a still image, a group of still images and a stream of image information.

9. The display system of claim 1 further comprising an audio system to generate audio signals based upon audio content stored in the write-once memory and display controller.

10. The display system of claim 1 wherein the image content is customized.

11. The display system of claim 1, wherein the display is a passive-matrix display.

12. The display system of claim 1, wherein the display is a reflective display.

13. The display system of claim 1, wherein the display uses bi-stable cholesteric materials to form images.

14. The display system of claim 1, wherein the display is a color display.

15. The display system of claim 1, wherein the display controller is a non-programmable state machine.

16. The display system of claim 1, wherein the display controller comprises a non-programmable logic circuit.

17. The display system of claim 1, wherein the display controller comprises only a memory interface and display deriver.

18. The display system of claim 1, further comprising an external interface adapted to receive at least one of image content and audio content and to store the received content in the write-once solid-state memory.

19. A display system comprising:
a display;
a write-once solid-state memory with image content stored in the write-once memory; and
a display controller adapted to read the write-once solid-state memory and to cause the display to present the image content, and
a folded surface on which any of the display, write-once solid-state memory, and display controller are mounted.

20. The display system of claim 19, further comprising a switch for activating the display controller.

21. The display system of 20, wherein the operation of unfolding the surface actuates the switch.

22. The display system of claim 19, further comprising an audio circuit to generate audio signals based upon audio content stored in the write-once memory and display controller.

23. A display system comprising:
a display;
a memory interface adapted to receive more than one type of write-once solid-state memory with each type of write-once solid-state memory having a different capacity for receiving image content; and
a display controller adapted to read image content stored a write-once solid-state memory received by the memory interface and to cause the display to present the image content.

24. The display system of claim 23, wherein the memory location is adapted to receive more than one type of write-once solid-state memory, with each memory type having different image content storage capacity.

25. The display system of claim 23, wherein the write-once solid-state memory has image content recorded therein before the write-once solid-state memory is received by the image interface.

26. The display system of claim 23, wherein the write-once solid-state memory has image content recorded therein before the write-once solid-state memory is received by the memory interface.

27. The display system of claim 23, wherein the display system takes the form of a tradable card.

28. The display system of claim 23, wherein the display system takes a form consistent with a sports card and wherein the image content in the memory has sports-related image content stored therein.

29. The display system of claim 23 further comprising a surface on which at least one of the display, the memory and the display controller are mounted.

30. A method for assembling a display system comprising:
providing a display;
providing a write-once solid-state memory; and
providing a display controller with the display controller, write-once solid-state memory, and display being functionally associated so that the display controller can read the write-once memory and can cause the display to present the image content stored in the write-once memory.

31. The method of claim 30, further comprising the step of writing image content into the write-once solid-state memory.

32. The method of claim 30, further comprising the steps of receiving customized image content and writing the customized image content into the write-once solid-state memory.

33. The method of claim 30, wherein image content is obtained in a first form, and further comprising the steps of converting the image content into a second form, and writing the converted image content into the write-once solid-state memory.

34. The method of claim 30, further comprising the step of storing the obtained image content in an archival storage medium.

35. The method of claim 30, wherein the step of providing a write-once solid-state memory comprises recording image content in the write-once solid-state memory and then functionally joining the write once solid-state memory to the display and display controller.

36. The method of claim 30, wherein the step of providing a write-once solid-state memory comprises determining a storage capacity requirement for storing a particular image content in a memory, selecting a write-once solid-state memory having sufficient storage capacity to store the image content, storing the image content in the selected write-once solid-state memory and functionally associating the selected write-once solid-state memory with the display and with the display controller.

37. A method of vending a display system having a display, a write-once solid-state memory and a display controller for reading the write-once memory and displaying the image content on the display, the method comprising the steps of:
obtaining image content;
storing the image content in the write-once solid-state memory;
selling the display system; and
delivering the display system.

38. The method of claim 37, wherein the step of obtaining content comprises capturing the image content.

39. The method of claim 37, wherein the step of obtaining the content comprises capturing audio and image content at a first location and the step of delivering the display system comprises delivering the display system to the first location.

40. The method of claim 37, wherein the step of obtaining the content comprises capturing audio and image content at a first location and the step of delivering the display system comprises delivering the display system of the second location.

41. The method of claim 37, wherein the step of providing a write-once solid-state memory comprises recording image content in the write-once solid-state memory and then functionally joining the write once solid-state memory to the display and display controller.

42. The method of claim 37, wherein the step of providing a write-once solid-state memory comprises determining a storage capacity requirement for storing a particular image content in a memory, selecting a write-once solid-state memory having sufficient storage capacity to store the image content, storing the image content in the selected write-once solid-state memory and functionally associating the selected write-once solid-state memory with the display and with the display controller.

43. The method of claim 42, wherein the step of selling the display system comprises providing determining a selling price based at least in part upon the memory capacity of the selected write-once solid-state memory.
